(19) United States
(12) Patent Application Publication
(10) Pub. No.: US 2003/0004764 A1
(43) Pub. Date: Jan. 2, 2003

(54) Air carrier service evolution model and method

(76) Inventor: William P. Niedringhaus, McLean, VA (US)

Correspondence Address: ROSENBERG, KLEIN & LEE, 3458 ELLICOTT CENTER DRIVE-SUITE 101, ELLICOTT CITY, MD, 21043, US

(21) Appl. No.: 09/895,250

(22) Filed: Jul. 2, 2001

(51) Int. Cl. G06F 17/60

(52) U.S. Cl. 705/7

(57) ABSTRACT

Air carrier service evolution model and a method of simulation the economics of airlines for aiding the airlines to make optimized marketing decisions in view of transient market forces effecting the airline. The air carrier service evolution model and the method of simulation the economics of airlines is based on agent-based model in which changes responsive to market forces, as well as interaction between the market forces, and anticipated changes in market forces. The market decisions are made in view of the information concerning bankrupt airlines, newly located airports, financial situation of each airline, newly established airlines, flights available for each destination, passenger demand, ratio of leisure and business passengers, etc. For each airline, parameters are simulated and modified for the maximum profit such as fares, aircraft size, scheduled departure, as well as a number of other operational parameters.

### FIELD OF THE INVENTION

The present invention relates to a method of improving the economics of airlines, and more particularly to a method of simulating the economics of airlines, taking into consideration market forces affecting airlines.

The present invention further relates to an air carrier service evolution model and software, implementing the air carrier service evolution model used as a tool for improving the economics of airlines.

Even more particularly, the present invention relates to an agent-based air carrier service evolution model which takes into consideration and simulates not only a large number of market forces which affect the economics of airlines, but also the interaction between the simulated market forces.

### BACKGROUND OF THE INVENTION

There exists a large number of market forces which affect economics of airlines, such as fluctuation in the price of fuel, changes in capacity of airports, improvement in air traffic control systems causing decreases in flight time, introduction of new kind of airplanes, etc. All of these factors and many other changes influence the economics of airlines and directly impact profits and/or losses. Other factors taken into account include convenience of passengers, number of people employed to provide services for airlines, etc. Not only do the market parameters directly influence the economics of airlines themselves, the interaction between the market parameters also affect the evolution of airline productivity and effectiveness.

Prior art systems and models exist which allow for tracing and determining how the current or past changes of market forces can affect the economics of airlines. These prior art systems and models, however, fail to take into consideration the effect of possible interaction between the changing market forces on the economics of airlines. In general, they are not intended to anticipate future market changes and innovations which may or may not happen in the future. Such systems do not anticipate changes and innovations which may interact with existing market force fluctuations, and in total do not forecast how these changes influence the economics of the airlines.

It is, therefore, understood that, despite the benefits of existing models for improving the economics of airlines, a method and model is still widely needed which provides a generally complete understanding of how existing and anticipated changes of market forces, taken in ever-changing interaction and combinations thereof may affect the economics of airlines.

### SUMMARY OF THE INVENTION

It is therefore an object of the present invention to provide a method for improving the economics of airlines on the basis of simulation of the economics of airlines in which a plurality of current and anticipated changes in market parameters are taken into account in combination with interactions therebetween.

It is a further object of the present invention to provide an agent based air carrier service evolution model which simulates possible changes of market forces which may affect airlines as well as possible interaction between the simulated market forces, and then determines how these simulated changes and interactions between the market forces may affect the economic health of the airlines.

In accordance with the present invention, a method of simulating the economics of airlines includes the steps of:

providing a computer run agent based air carrier service evolution model (ACSEM),

entering information concerning airline bankruptcy considerations, information concerning newly created airports, and financial considerations of individual airlines,

establishing and modifying for each airline, in accordance with individual airline operating procedures: fares, aircraft size, scheduled departures, fraction of seats reserved for different seat class accommodations, and itinerary cycles,

simulation and modification for each airline, parameters directed to a desired profit margin of each airline relating to the opportunity to sell and/or buy aircraft as well as parameters directed to shortening or lengthening itineraries.

The ACSEM further includes the steps of:

entering information concerning newly established airlines,

determining scheduled flights available from a point of departure to a point of destination,

entering information concerning passenger demand, and

entering information concerning leisure passengers and business passengers.

After entering the requested information, an algorithm simulating a day's traffic is applied which includes requesting in what state the aircraft is and exercising simulated action in accordance with the state of the aircraft. The state of the aircraft may include boarding, request take-off, take-off, enroute, request landing, landing, and idle. Requesting of the state of the aircraft and corresponding simulated action are repeated periodically up to sixty times an hour. After the simulation of the day's traffic is completed, the inclusive steps of the ACSEM are repeated in a pre-requested sequence to extrapolate a maximization forecast of the profits of the airline.

These and other novel features and advantages of this invention will be fully understood from the following detailed description and the accompanying drawings.

### BRIEF DESCRIPTION OF THE DRAWINGS

FIG. 1 shows schematically a system running air carrier service evolution model of the present invention;

FIG. 2 is a flow chart diagram showing the air carrier service evolution model of the present invention; and,

FIG. 3 is a flow chart diagram of a simulated day's traffic as a part of the air carrier service evolution model of the present invention.

### DETAILED DESCRIPTION OF THE PREFERRED EMBODIMENTS

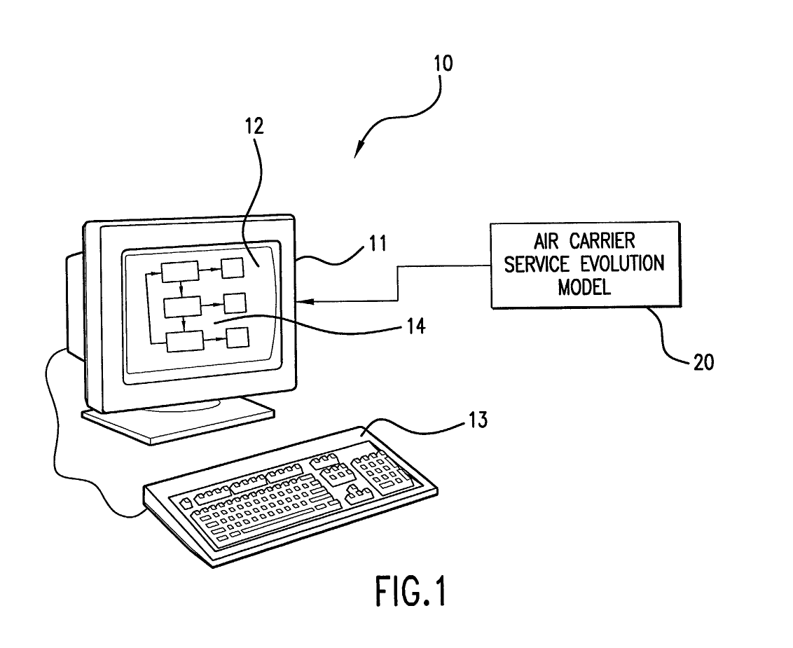

Referring to FIG. 1, a system 10 for implementing a method of simulating the operation and economics of airlines includes a computer 11 having a display 12 and a keyboard 13 (or any other means known to those skilled in the art for entering data), with a particular software adapted to run the computer 11 which implements an agent based air carrier service evolution model (ACSEM) 14 of the present invention. The ACSEM 14 of the present invention is an agent based model simulating a large number of entities (parameters) which interact each with the other, whereby interaction of the agents within the system affect the agents themselves and the final result of data processing.

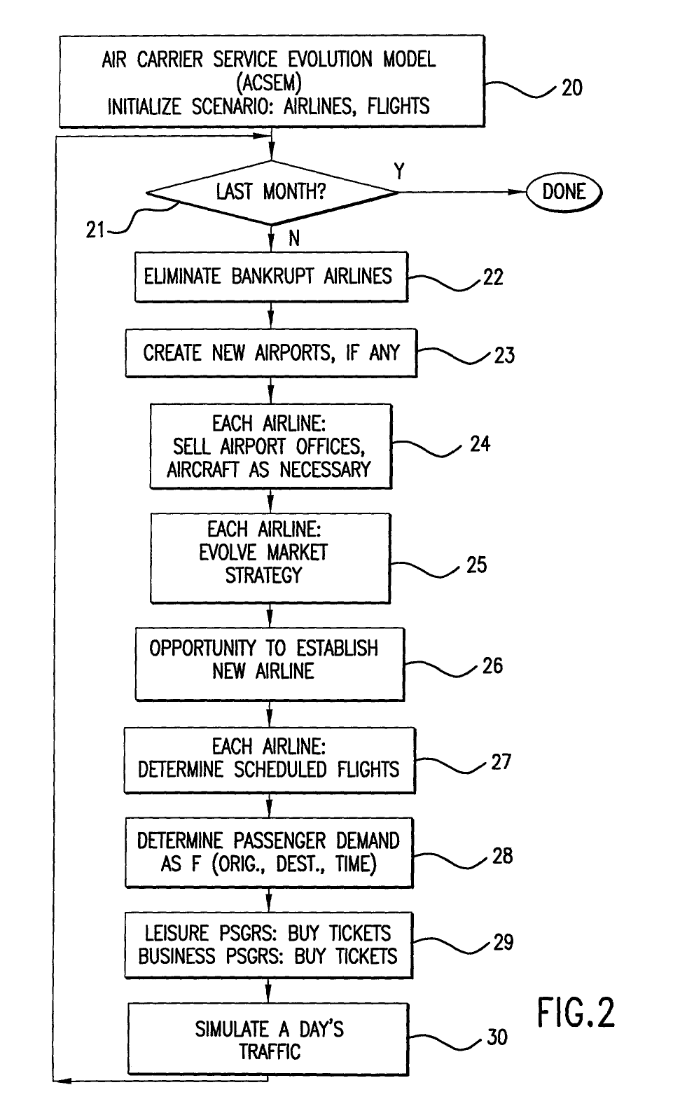

Referring to FIG. 2, the operation of ACSEM 14 is initiated in the flow block 20 “initialize scenario: airlines, flight” which is a significant piece of the code where the information is entered into the system 10 with regard to the current airline structure at the time a user wants to begin simulation. From the block 20, the program flows to the block 21 last month?”, which basically requests the user to input information as to whether the simulation is completed. If the answer is “Yes”, then the user is provided with the output information as will be developed in following paragraphs. If the answer is “No”, then the algorithm passes to the block 22 “eliminate bankrupt airline” in which the request is made to delete from the system those airlines which have entered into bankruptcy.

Upon completion of the step associated with the flow block 22, the procedure moves to the block 23 “create new airport, if any” which requests information concerning the opportunity of newly created airports. Since the present invention is involved in modeling evolution of the airline system over time when new airports may be brought into operation, this parameter influences and effects economics of existing and new airlines which is important data to be considered by the ACSEM 14. This information or data may be input into the computer 11 either as an explicit information with the name of geoegraphical location, date, and capacity of the airport, or it may be input by the computer 11, based on model assumption that new airports are created at certain periods of times in predetermined geographical locations, i.e., stochastically. For instance, having information on the rate of growth of certain cities, the ACSEM may add a new airport into the system when a city reaches a certain size.

From the block 23, the logic enters the flow block 24 “each airline: sell airport processes, aircraft, as necessary”. In this section of the model, a financial situation of an airline is inputted in the system. For instance, if an airline experiences downsizing or is experiencing financial concerns, the airline is given the opportunity of selling assets to bolster its economic position. This financial information may also affect the overall profit of airlines and therefore is an important piece of the code.

Each airline has to make marketing decisions, i.e., where to fly, when to fly, what kind of airplanes to fly, how much to charge for tickets in order to provide a predetermined profit margin and to reach a desired profitability of the airline. Thus, to respond to this requirement, the program proceeds from the block 24 to the block 25 “each airline: evolve market strategy”, which represents the marketing strategy when the airline has to make a marketing decision. In the block 25, the set of the evolve market strategy tools is presented which falls in two categories: (a) Hill-Climbing Tools, and (b) Other Tools. The Hill-Climbing Tools include the following procedures:

adjust fares (per airline, per origin destination),

adjust aircraft size (per airline, per aircraft),

adjust scheduled departure times (per airline, per aircraft, per departure),

adjust fraction of seats reserved for business traffic (per airline, per itinerary leg), and

cycle around itinerary (per airline, per aircraft).

To set the fares, an initial value is chosen at random, and the fare is changed (each fare applies to a particular airline for a particular route, for a particular origin to destination). For example, if the fare from Boston to New York is set at an initial value of $100.00, then the next month a slightly different ticket price of, for instance, $102.00 is tried. The profit on the Boston to New York route with the price of the ticket of $102.00 is compared with the profit of the same route with the tickets of $100.00. If the profit was higher, then in the next iteration, the price of the ticket is increased to, for instance, $104.00, and the new profit corresponding to the ticket price of $104.00 is compared with the previous profit corresponding to $102.00 price. If the profit margin using the higher price of ticket was lower, then the model decreases the price below the highest price but above the previous lower price, and analyzes the profit. It is therefore clear to those skilled in the art that the Hill-Climbing technique (which is a well-known strategy in mathematics) is applied in the market strategy of the present invention. Adjusting of the fares is based on analyzing the profitability of airline at different prices, fluctuating around a pre-set value and adjusting the fares accordingly.

The same fluctuations of fares are simulated for all airlines and for all origin-destination routes available in those airlines. Since the changes in fares on one airline may affect fares on another, as well as changes of fares on one origin-destination may influence changes in fares on another, all fluctuations exist in an ever-changing flux of fares with the marketing decision being made on the basis of the overall changing flux of data concerning fares. When the ACSEM 14 simulates and modifies fares according to the profit-loss, other parameters involved in making a marketing decision are maintained constant.

In the flow block 25, the simulation and modification of the aircraft size, scheduled departure, fraction of seats reserved for business and cycle around itinerary are performed in similar way to the modification of fares, one parameter at a time, while others are held constant. For instance, when the procedure of modification of aircraft size is performed, an aircraft size is randomly pre-set, for one airline and for a particular aircraft and the profit for this particular aircraft size is determined. In the next iteration, the size of this particular aircraft is increased and the profit for this increased aircraft size is determined and compared with the previous profit. If the profit in the succeeding iteration is higher then the aircraft size is further increased and the third profit corresponding to the furthermore increased aircraft size is determined and compared with the previous profit. If the third profit is higher than the second profit, then the aircraft size is further increased, but if the third profit is below the second profit, then the size of the aircraft is reduced to the maximum profit obtained through modification in aircraft size. Aircraft sizes are changed for each airline and for all aircrafts, and these modifications for all airlines and all aircrafts are taken in consideration in the ACSEM since they interact with and are dependent on one another.

Another category of the Evolve Market Strategy tool includes the following simulations:

sell aircraft, e.g., those losing money or with poor prospects,

buy aircraft, e.g., when unmet demand is sensed,

shortened itinerary, i.e., drop a poorly performing leg,

lengthen itinerary, i.e., include potentially lucrative leg.

For instance, when the tool “sell aircraft” of the flow block 25 is applied, the simulation is made that a certain aircraft is sold, and the profit in this situation is determined. If the profit is higher with the aircraft sold, then this is a proper decision. However if the profit is lower when the aircraft is sold, then this marketing decision is deemed poor and the aircraft is kept in operation. The same simulations are made with other tools, i.e., buy aircraft, shortened itinerary, or lengthen itinerary under the condition that only one tool is applied at a time while others are kept constant.

Each Evolve Market Strategy tool (including Hill-Climbing Tools and Other Tools) described in the previous paragraphs may be used in several cycles consecutively or alternatively in isolation.

As can be understood by the above discussion, each Hill-Climbing Evolve Market Strategy Tool:

governs a parameter (e.g., fare, aircraft size, scheduled departure times, etc.)

raises/lowers an isolated parameter if similar action previously increased the profit;

otherwise lowers/raises the isolated parameter;

amount of the change applied to the isolated parameter accelerates with repeated success (with the technique referred to as “Accelerated Hill Climbing”);

amount of change decelerates and reverses direction with repeated failure.

The brief description of the technique of Hill-Climbing discussed in the previous paragraphs can be easily understood in analogy to a person on a road trying to find the top of the hill. The person advances uphill for a certain number of steps and once the person's first step is downhill, then the person reverses the direction of advance and keeps advancing until he or she finds him/herself going downhill again. The person thus is provided with an iterative procedure to hone in on the apex of the hill.

The technique of Accelerated Hill-Climbing means that if the person found that he/she going uphill for a certain number of times in a row, then he/she starts taking longer steps. But when the person suddenly realizes that he/she has gone downhill, then he/she reverses and starts taking shorter steps. This is considered as a Decelerated Hill-Climbing. As it is clear from the above discussion, the Decelerated Hill-Climbing in reverse direction is used when repeated profit loss is determined.

The technique used in the Evolve Market Strategy block 25, as disclosed in previous paragraphs, for each airline, allows the user to make a valid marketing decision with regard to fares, size of aircraft, time of scheduled departure, seats reserved for business, cycles around itinerary, opportunity to sell or buy aircraft, shortening or lengthening itineraries.

After the decision is made regarding the above parameters, the Air Carrier Service Evolution Model proceeds from flow block 25 to the flow block 26 “opportunity to establish new airline”. In the block 26, the request is made whether a new airline emerges. Responsive to this request, the corresponding input is made either in the explicit form or is generated by the model according to a schedule in which a new airline would emerge periodically if conducive economical conditions exist.

Upon completion of the procedure associated with the flow block 26, the algorithm enters the flow block 27, “each airline: determine scheduled flight”, in which for each airline, the system calculates exactly when each airplane for a particular airline is in operation. All these routes are compiled in a guide, similar to an Official Airline Guide, in which all possible transfers are determined which would allow a passenger to transfer from one route to the other; in other words in the block 27, all possible tickets are found which are available for the passenger to fly from origin to destination at a desired time.

The procedure further enters the flow block 28 “determine passenger demand as F (original, destination, time)”, in which the request is made and the corresponding input is made into the system for each origin, destination, and time, and the number of people which desire to use the flights with these parameters. Again, with all other inputs in the system of the present invention, the input responsive for the request made in the block 28 may be made explicitly or by the computer 11 which may generate the input according to a certain statistic plan. The part of the ACSEM associated with the block 28, represents the interaction of supply and demand, the supply being the number of airplanes available, what airplanes fly and where, and the demand being on how many people want to fly within the parameter restrictions.

The logic flows to the block 29, in which the request is made and the input is entered of the number of leisure passengers and business passengers buying tickets for each class. The assumption is made from the experience of airlines that leisure passengers usually do not care when they fly, but they are price sensitive. While business passengers generally wish to fly at a certain time and are not as price sensitive. Leisure passengers typically reserve their tickets ahead of time, while the business passengers usually buy the tickets shortly before the needed flight. Therefore, the business passengers who buy tickets on the same day of the flight are expected to pay a premium rate. The airlines usually allow a certain number of tickets to be sold ahead of time at a lower price, and then keep on hold a certain percentage of seats that are going to be charged at higher prices for business passengers. As is clear, the percentage of leisure passengers and business passengers is an important piece of information which greatly effects profit of the airline. All input parameters, corresponding to the flow blocks 22-24 and 26-29, as well as marketing decisions made in the block 25, are important parameters influencing profit of airlines, and therefore are taken into consideration in the model of the present invention.

The information input according to the blocks 27-29 is important since it gives an understanding to the airline of whether they are able to meet the demands of the passengers, and if not, may factor in the decision to buy a new airplane.

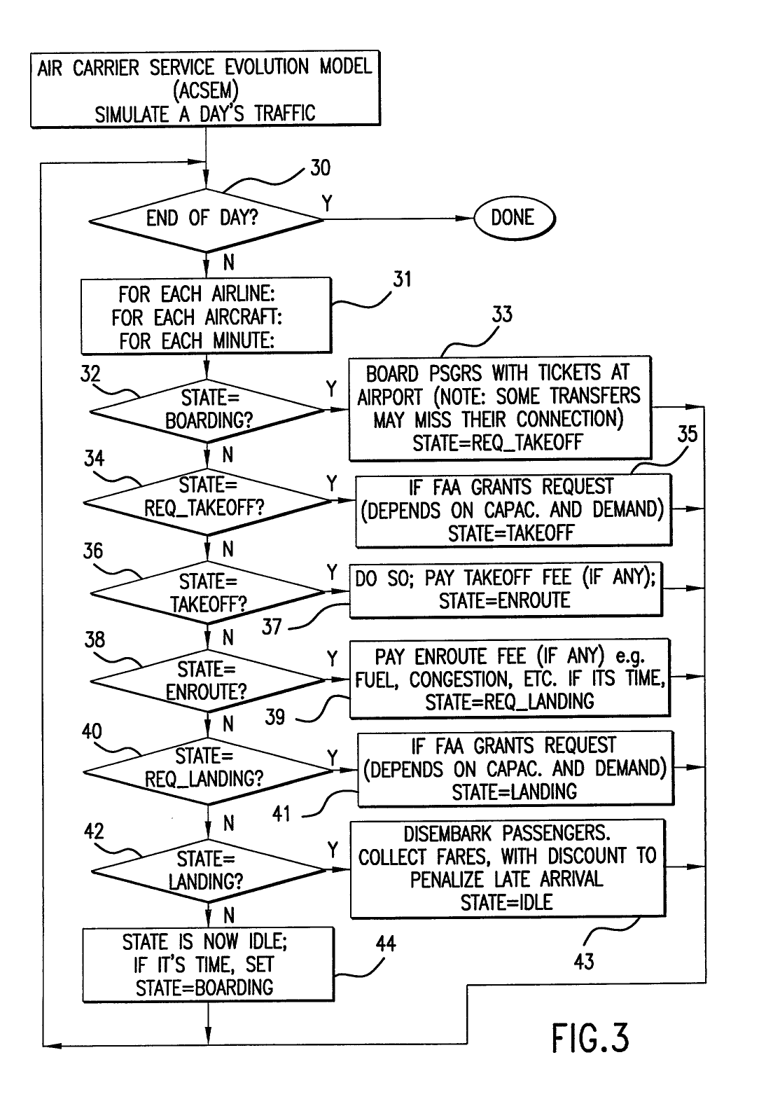

From the block 29, the procedure flows to and enters block 30 “simulate a day's traffic”, best shown in FIGS. 2 and 3, representing simulation of the flight of an airplane and allowing it to proceed through the day, minute by minute. As best shown in FIG. 3, the situation is simulated in which each aircraft progresses through a cycle of states, which starts with boarding, and moves through the following states: requesting take-off, take-off, enroute, request landing, landing, idle, and then returns to the boarding state again when the aircraft is ready to fly another route, or another leg of the itinerary.

In the FIG. 3, the flow block 30 requests end of day. If it is the end of the day, then the simulation is done. Simulation results may then be printed and studied as to changing various parameters. If it is not the end of the day, then for each airline, each aircraft and each minute, as represented in the block 31, the systems asks the state of the airplane. There are seven states in which the airplane may be in, including boarding, request take-off, take-off, enroute, request landing, landing, or idle. Depending in which state the airplane is, it exercises one of the seven decision blocks (to be discussed further herein). In some cases, the system moves on to the next state, and in other cases, it stays at the same state. Advancement through all the states is performed cyclically for each minute of the day, for each airline and for each aircraft, starting with the flow block 32 which asks whether the state of the aircraft is “boarding”. Basically the question is whether the aircraft is ready to board the passengers. If the answer is “Yes”, then passengers at the airport with tickets on this flight can be boarded on the airplane as shown in block 33. There may be a possibility that some passengers were trying to transfer to that particular airplane, but they missed their connection. In this case, they are not boarded on the airplane. Those passengers with the tickets, as long as they are at the airport, are allowed on the airplane, and as shown in the flow block 33, the logic moves to the “request take-off” (block 34).

If the aircraft is in the state “boarding”, then the procedure does not move to decision block 34 “request takeoff”, until the next time the simulation passes through all states, i.e., the next minute. In this scenario, the system delays one minute, and the logic cycles through the loop comprising all the sates of the airplane. Once the state of the aircraft is answered “yes” in the “request take-off” block, the procedure enters the decision block 35, in which the simulation is made representing FAA regulations which “looks” at the airport in which the aircraft is staying, and decides to allow take-off or not.

If poor weather conditions exist, such as blizzard or fog, in accordance with the weather condition data pre-input to the system, then the simulation is made that only one airplane is allowed to leave in a predetermined time interval. If the weather conditions are acceptable, the simulation determines that an airplane can leave in a shortened time interval. If there are several airplanes which want to leave at the same time, the simulation is made in accordance with FAA regulations as to which one takes off and which one is delayed. The purpose of this portion of the simulation is to evaluate the effect of possible rules such as “first come-first serve” as well as other rules to see what effect this route may have on other operating procedures.

If the response to the decision block 34 is “Yes”, the system then moves to the flow block 35 if the simulation is made that FAA grants request. If the response to the block 34 is “No”, then the system goes through a logic loop and returns back to decision block 34 in the next minute. Continuous looping occurs until the answer in block 34 is “Yes”.

If the FAA has granted the request, the system moves to the state “take-off”, as shown in block 35. In the next pass through the loop in FIG. 3, the system proceeds to the state “take-off”, decision block 36. If the aircraft is in the state “take-off”, the system moves to the flow block 37 in which the simulation is made that the aircraft “took off” and the “take-off fee” should be paid. There exists a possibility that airports charge a fee to use the airport. Each time an aircraft takes off fees are charged for fuel, etc., and the simulation is made in the flow block 37 to reflect these operational costs. The simulation made in the block 37 is an important piece of the system since a trade-off may be made between whether to run the airplane only once from an originating point to a destination point, or several times, since if the airplane is operated several times, the airport fees are increased which greatly effects the airline profit margin.

When the aircraft took off, the state of the aircraft is changed to state “enroute”, as shown by decision block 38. If the aircraft is in state “enroute”, the simulation is made in the block 39 in which the airplane has to pay enroute fees reflecting how much fuel the aircraft uses or how busy the area over which the aircraft intends to fly. If the aircraft is going to pass through a very congested area, an extra cost must be added to enroute fee.

The simulation is run two times with an added cost for congestion of the area and without any congestion. The idea is that if the simulation action charges more for flying the aircraft through congested sectors, the airlines will, in order to avoid these extra fees, route their traffic to less congested tract sectors. The simulation determines whether congestion will exist for a particular flight, and how all parameters interact with each other. The enroute fee may thus be a constant, or it may be a reflection of how busy the sector in which the airplane is flying.

After being in state “enroute”, and going through the entire loop again, the system moves to the state “request landing”, as shown in decision block 40. Depending on capacity of the airport of destination, demand and weather conditions at this airport, the simulation is made as to FAA granting or not granting the request. The request can be granted immediately or the airplane has to circle the airport. This will be reflected by an imposed landing fee. The landing fee is basically enroute fee paid either in the state “enroute” or in the state “request landing”. If the simulation is made that the FAA granted the request, then the aircraft passes to the state “landing” as shown in block 41. The logic proceeds again through the entire loop and enters the state “landing?”, as shown by the decision block 42. When the aircraft has landed, the passengers are disembarked, and fares are collected with discount as simulated in block 43. The simulation made in the block 43 handles passengers discounted in the following way: the assumption is made that part of the competition between airlines is to be at the airport of destination on time, and the way that the system of the present invention regards airlines for being on time is that they collect their full fare. The way the simulation in the block 43 reflects a passenger's decision not to fly a certain airline because they were late, is to not to allow the airline to collect their full fare if they land late.

After the simulation is made in the flow block 43 to disembark passengers and collect fares for late arrival, the logic enters the state “idle” as shown in block 44. The airplane may have to stay in the state “idle” for a certain period of time which may be extended to hours before it is ready to board. The period of time the airplane is allowed to be idle is a function of whether the airline wishes to fly the airplane in an extended flight time manner or whether the airline desires to fly the airplane in a lessened operational time mode. This is a marketing strategy of the airline which heavily reflects on the profit of the airplane. When the simulation is made according to the marketing strategy of certain airlines and the aircraft is ready for boarding, the logic loop returns to the beginning of the flow block 30. The system moves through the loop shown in FIG. 3 each minute for each airline and for each aircraft. If the simulation of the day's traffic is completed, then as shown in FIG. 2, the air carrier service evolution model re-enters from the block 30 to the beginning of the block 21 and this loop is passed cyclically as many times as needed to accomplish the simulation and to obtain the results of the simulation.

The system as disclosed in the previous paragraphs may be used by airlines when the airlines want to analyze certain changes in their policies, or it may be used by the FAA if the FAA wants to understand what effects certain policies may have. The airlines would need the system of the present invention in order to more clearly understand how to react to changes in the market forces in order to maximize profit margins.

The information input according to the boxes 27-29 is important since it gives a certain understanding to the airline of whether they are able to meet the demands of the passengers, and if not may drive the decision to buy new airplanes.

Although this invention has been described in connection with specific forms and embodiments thereof, it will be appreciated that various modifications other than those discussed above may be resorted to without departing from the spirit or scope of the invention. For example, equivalent elements may be substituted for those specifically shown and described. Certain features may be used independently of other features and in certain cases, particular locations of elements may be reversed or interposed, all without departing from the spirit or scope of the invention as defined in the appended claims.

What is claimed is:

1. A method of simulation the economics of airlines, comprising the steps of:
providing processing means,
establishing an agent-based air carrier service evolution model (ACSEM) and processing said ACSEM on said processing means through the steps of:
(a) entering information concerning bankrupt airlines, newly created airports, and financial conditions at each airline;
(b) individually setting and modifying at least one of the following parameters according to a desired profit for each airline:
fares per airline and per origin-destination;
aircraft size per airline, per aircraft;
scheduled departure per airline, per aircraft, per departure;
fraction of seats reserved for business, per airline, per itinerary leg; and
cycles around itinerary, per airline, per aircraft;
(c) simulating at least one of the following conditions and modifying said at least one condition according to a predetermined profit margin of each airline:
sell aircraft;
buy aircraft;
shorten itinerary; and
lengthen itinerary;
(d) entering information concerning a newly established airline;
(e) for each airline, including said newly established airline, determining scheduled flights available to fly from a point of departure to a point of destination;
(f) for each said airline, including said newly established airline, entering information concerning passenger demand;
(g) entering information concerning leisure passengers and business passengers;
(h) cyclically simulating a day's traffic at predetermined time intervals for each of said airlines and each of said aircraft, comprising the steps of:
requesting what is the state of the aircraft,
exercising a simulated action in accordance with the state of the aircraft, and
repeating said steps of the simulating a day's traffic, each predetermined period of time; and
(i) repeating the steps a-h in sequence to maximize profit of the airline.

2. The method of claim 1, further including the steps of:
before the step (a), entering in said processing means information concerning current airline structure.

3. The method of claim 1, wherein in the step (a), said information concerning newly created airports includes place and date of establishing the new airports.

4. The method of claim 1, wherein in the step (a), said information concerning newly created airports includes anticipation parameters.

5. The method of claim 1, wherein in the step (a), said information concerning financial conditions at each airline includes information on opportunity to sell airport offices and aircrafts.

6. The method of claim 1, wherein in steps (b) and (c), modifying of each of said parameters and each of said conditions is performed individually while holding the other of said parameters constant.

7. The method of claim 1, wherein in the step (f), the information concerning passenger demand is entered as explicit data.

8. The method of claim 1, wherein in the step (f), the information concerning passenger demand is generated by said processing means in accordance with a predetermined statistical model.

9. The method of claim 1, wherein in said step (h), said states of the aircraft include:
boarding;
request take-off;
take-off;
enroute;
request landing;
landing; and
idle.

10. The method of claim 9, wherein said step of requesting the state of the aircraft is repeated each minute.

11. The method of claim 9, wherein in the state “boarding”, the simulated action includes boarding of passengers with tickets of this flight.

12. The method of claim 9, wherein in the state “request take-off”, the simulated action includes granting take-off depending on capacity of the airport and demand.

13. The method of claim 9, wherein in the state “take-off”, the simulated action includes paying take-off fee.

14. The method of claim 9, wherein in the state “enroute”, the simulated action includes paying enroute fee, based on fuel consumption and reflecting area congestion.

15. The method of claim 9, wherein in the state “landing”, the simulated action includes disembarking passengers and collecting fares with discount to penalize late arrival.
